(19) United States
(12) Patent Application Publication
(10) Pub. No.: US 2002/0184116 A1
(43) Pub. Date: Dec. 5, 2002

(54) Data structure for holding product information

(75) Inventors: Richard K. Tam, Monte Sereno, CA (US); Mark A. Resmer, Campbell, CA (US)

Correspondence Address: SKJERVEN MORRILL LLP, 25 METRO DRIVE, SUITE 700, SAN JOSE, CA, 95110, US

(73) Assignee: iUniverse.com

(21) Appl. No.: 09/827,200

(22) Filed: Apr. 4, 2001

(51) Int. Cl. G06F 17/60

(52) U.S. Cl. 705/27

(57) ABSTRACT

An entity (hereafter “aggregator”) acts as a repository to which sellers submit descriptive information about a product or service available for sale, and business rules (collectively called “product package”) to be used in selling the product or service to buyers. Sellers submit their product packages in a predetermined format (e.g., as a XML file) where individual information within each package are identified by descriptors (e.g., XML tags). The aggregator compiles the product packages from one or more sellers into a catalog that is distributed to buyers as an online catalog, an electronic catalog on a multimedia disk, or a paper catalog. The aggregator customizes the content of the catalog for different buyers and areas of distribution according to the business rules for the products. The catalog can include legally binding offers with words of commitment to sell and specific terms generated from the business rules.

### CROSS-REFERENCE TO RELATED APPLICATIONS

This application is related to and incorporates by reference herein the commonly owned co-pending U.S. patent application Ser. No. ______, “E-COMMERCE USING AN IDENTIFIER,” inventors Tam et al., filed ______, attorney docket number M-9127 US, U.S. patent application Ser. No. ______, entitled “E-COMMERCE USING A CATALOG,” inventors Tam et al., filed ______, attorney docket number M-8689 US, and U.S. patent application Ser. No. 09/536,192, entitled “REPOSITORY FOR PUBLISHING CONTENT IN DIFFERENT FORMS,” inventors Tam et al., filed Mar. 17, 2000.

### BACKGROUND

A catalog is a publication containing a systemized list of items that often features descriptions of the listed items. Manufacturers and retailers distribute product catalogs to buyers to generate product sales. Manufacturers and retailers generally publish their catalogs independent of other manufacturers and retailers. Thus, a typical catalog contains only advertisements for products made by a single manufacturer or products sold by a single retailer.

### SUMMARY

Buyers in accordance with the invention make purchases from a catalog that contains information about product (or service) and business rules (collectively called “product package”) that govern sale of the product (or service). Specifically, the business rules are rules used to form a sales contract between a seller and a buyer, without any further involvement of the seller in contract formation. Depending on the embodiment, the product package contains either (a) the specific terms of an offer sufficient to form a legally binding contract when accepted by a buyer or (b) business rules that when executed by a computer generate the specific terms of an offer to form a legally binding contract. So, a sales contract can be formed at a buyer's premises in the physical absence of and even without online interaction with a seller, e.g. by the buyer's use of the business rules.

### BRIEF DESCRIPTION OF THE DRAWINGS

FIG. 1 illustrates, in a block diagram, a commerce system for generating a catalog in one aspect of the invention.

FIG. 2 illustrates, in a block diagram, a computer system for implementing the commerce system of FIG. 1 in one embodiment of the invention.

FIG. 3 illustrates, in a flow chart, a method to generate a product package by a seller computer of FIG. 2.

FIG. 4 illustrates, in a flow chart, a method implementing an action in the method of FIG. 3.

FIGS. 5A to 5R illustrate, in block diagrams, dialog boxes where sellers provide product information and business rules used to generate a product package of FIG. 1.

FIG. 6 illustrates, in a flow chart, a method to generate a catalog by an aggregator computer of FIG. 2.

FIG. 7 illustrates, in a flow chart, a method implementing an action within the method of FIG. 6.

FIG. 8 illustrates, in a block diagram, a listing in a catalog generated by the aggregator computer of FIG. 2.

The use of the same reference symbols in different drawings indicates similar or identical items.

### DETAILED DESCRIPTION

In one embodiment, sellers submit product packages to an organization (“aggregator”) in an online manner, in a document of a predetermined format (e.g., as an XML file) where individual information are identified by descriptors (e.g., XML tags). The aggregator compiles the product packages from one or more sellers into a catalog, and distributes the catalog to buyers, e.g. as an online catalog, an electronic catalog on a computer disk, or a paper catalog. The aggregator may customize the content of the catalog to specific buyers and/or regions, where the catalog is distributed according to the content e.g. according to product descriptions of the product packages. For example, descriptions of meat may be excluded from a catalog being provided to a vegetarian buyer. As another example, a catalog can be targeted to buyers and/or regions that are more responsive to the products of the sellers in order to generate greater sales.

The catalog generated by the aggregator can include product descriptions from a variety of sellers. Thus, the catalog provides a comprehensive tool for the buyer to search for products and to comparison shop among the sellers. The catalog generated by the aggregator can also be customized according to the business rules of the products. For example, a catalog may be customized to only contain product packages that offer a predetermined amount of discount (e.g., 20%), depending on a buyer's attributes.

An aggregator can generate a catalog that sells the same product from a variety of sellers. Thus, the buyers can purchase the product from the seller offering e.g. the best price, or best service, or best inventory depending on which of these factors is important to an individual buyer. Multiple aggregators can generate catalogs that sell the same product from the same seller. Thus, the aggregators compete with each other through the content and the marketing of their respective catalogs.

In one embodiment, the listings of the products in the catalog include legally binding offers to sell defined by the business rules received in the product packages. Unlike many advertisement that are not offers to sell, the listings of the products in the catalog include either specific terms or words of commitment to sell, or both depending on the example. Such offer language may be either present in the catalog or may be created by a buyer's computer when loaded with appropriate software (which may execute one or more business rules when preparing an offer).

A first aggregator can distribute a product package to a second aggregator. Both aggregators can provide product information for inclusion in another catalog. The aggregators in the distribution chain of a product package can be recorded in the product package so the seller can compensate all the aggregators in the distribution chain when a product is sold.

Depending on the embodiment, the catalog may contain the actual product to be sold if the product can be stored in the catalog. For example, an electronic catalog may hold one or more books and/or music albums in an encrypted manner and such product may be made available to the buyer instantaneously, in response to the buyer's approval of a purchase. Moreover, depending on the business rules accompanying the product, such products may be made available free of charge on a limited basis (single viewing for example). Alternatively, samples of such products may be included (e.g. a soap or scent sample may be packaged into a paper catalog) in the normal manner.

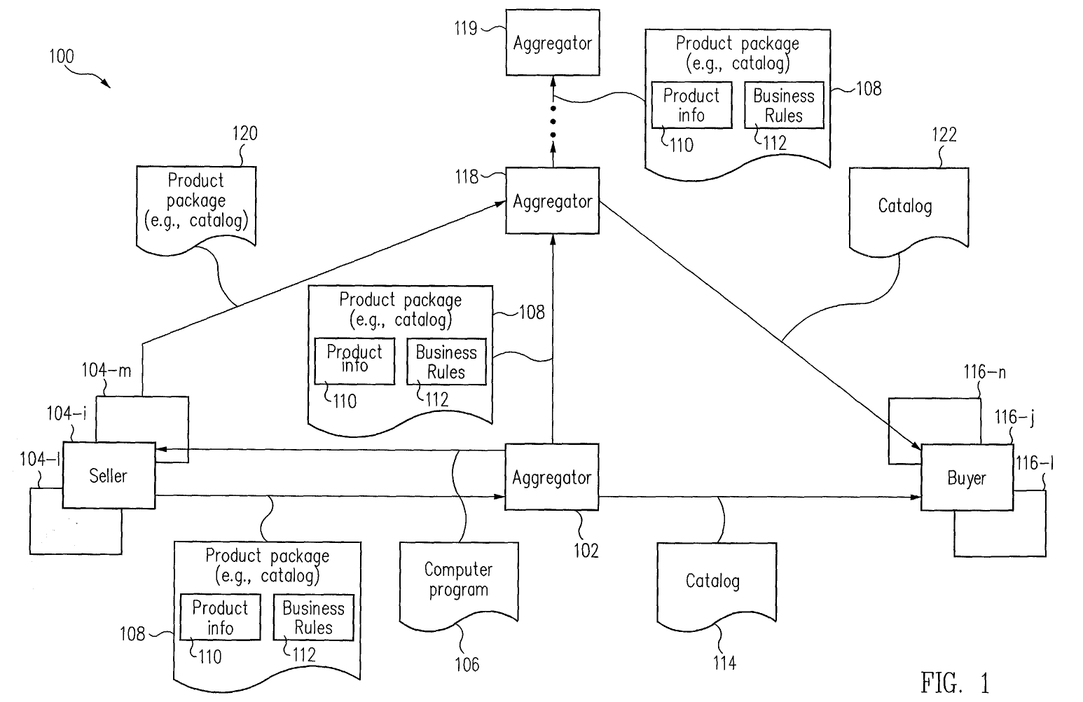

In accordance with one aspect of the invention, a commerce system 100 (FIG. 1) includes an entity (hereafter “aggregator”) 102 that sends to sellers 104-1 . . . 104-i . . . 104-m (1≦i≦m, where m is the total number of sellers) a computer program 106 for authoring product information and business rules (“product packages”) of one or more products (including services) for sale, in a document of a predetermined format. Product information include any information that may interest buyers in their decision to purchase products. Business rules include any convention that sellers use to govern their behavior in their efforts to sell products. For example, aggregator 102 sends program 106 to seller 104-i. Sellers 104-1 to 104-m include retailers, distributors, importers, brokers, resellers, manufacturers, and other entities that sell products. In some embodiments, sellers 104-1 to 104-m use program 106 with conventional publishing software to author product packages in the predetermined format (a process later described). In other embodiments, program 106 is a stand-alone computer program that sellers 104-1 to 104-m use to author product packages in the predetermined format. Sellers 104-1 to 104-m send their product packages to aggregator 102. For example, seller 104-i sends a product package 108 that includes product information 110 and business rules 112.

In some embodiments, aggregator 102 compiles the product packages from sellers 104-1 to 104-m into a catalog 114. As used herein, the term “catalog” is intended to be inclusive of (but not limited to) any mechanism for systematic enumeration of a number of products available for sale (or lease), with descriptions and/or illustrations of the products and their prices. Aggregator 102 sends catalog 114 to buyers 116-1 . . . 116-j . . . 116-n (1≦j≦n, where n is the total number of buyer) in paper and electronic forms to generate sales of the products offered for sale by sellers 104-1 to 104-m. For example, aggregator 102 sends catalog 114 to buyer 116-j.

In other embodiments, aggregator 102 sends the product packages from sellers 104-1 to 104-m to another aggregator 118. For example, aggregator 102 sends product package 108 to aggregator 118. Aggregator 102 can add, remove, or edit product entries in product package 108 before sending it to aggregator 118. Other sellers can also submit product packages to aggregator 118. For example, seller 104-m sends a product package 120 to aggregator 118. Aggregator 118 can also send product package (e.g., product package 108) to other aggregators (e.g., aggregator 119).

Aggregator 118 compiles product packages from sellers and aggregators into an aggregated catalog 122. Aggregator 118 sends catalog 122 to buyers 116-1 to 116-n in paper and electronic forms to generate sales of the products from sellers 104-1 to 104-m. For example, aggregator 118 sends catalog 122 to buyer 116-j. Although only aggregators 102, 118, and 119 are shown, commerce system 100 can include any number of aggregators.

Aggregators 102 and 118 can generate catalogs that sell the same product from the same seller. For example, aggregators 102 and 118 can both sell a product from seller 104-i in their respective catalogs 114 and 122. Seller 104-i compensates aggregators 102 and 118 for sales generated from their respective catalogs 114 and 122. In this situation, aggregators 102 and 118 compete with each other through the content and the marketing of their respective catalogs 114 and 122.

Sellers 104-1 to 104-m can sell the same product through one or more common aggregators. For example, seller 104-i and 104-m sell the same product through aggregator 118. In this situation, sellers 104-i and 104-m (such as Sears and JC Penney) compete with each other through their quality of service to the buyers (e.g., friendly staff and prompt delivery), their business rules (e.g., terms and conditions of sales such as price and return policy), and their inventory (e.g., availability of goods).

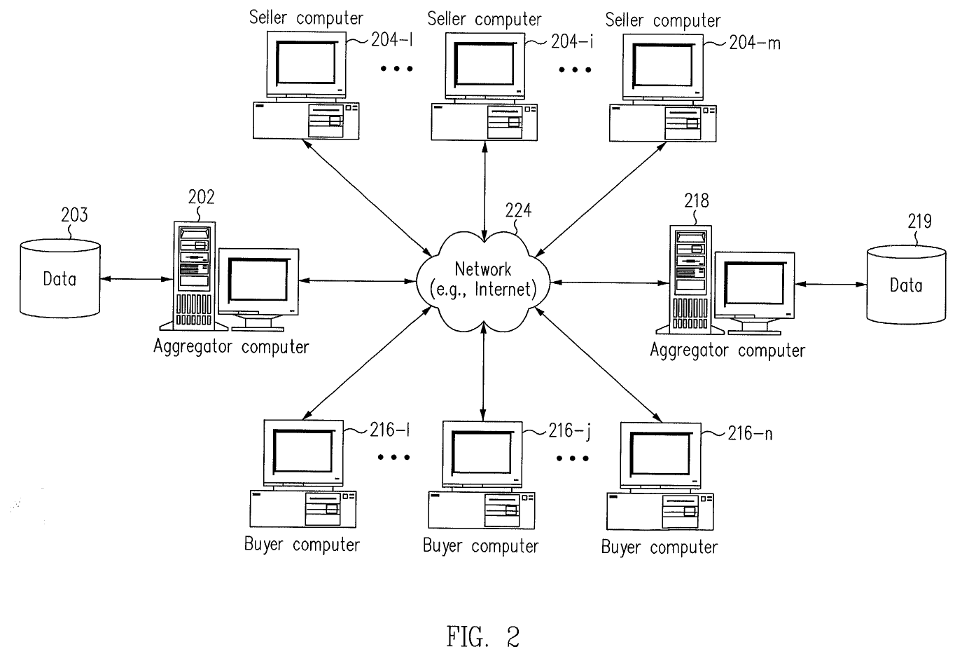

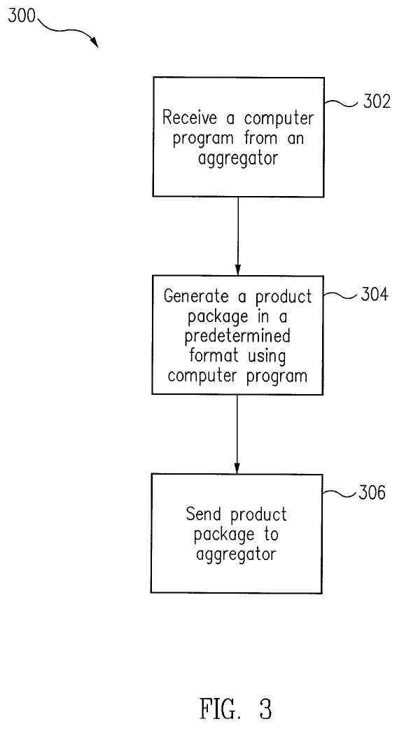

Method 300 (FIG. 3) illustrates the actions of a seller computer 204-i (FIG. 2) used by seller 104-i in one embodiment of the invention. In action 302 (FIG. 3), seller computer 204-i receives program 106 via a network 224 (FIG. 2) from an aggregator computer 202 used by aggregator 102 in the normal manners (e.g., using HTTP or FTP). Network 224 is, for example, the Internet.

In action 304 (FIG. 3), seller computer 204-i generates product package 108 in a document of a predetermined format using program 106. In some implementations, seller computer 204-i uses program 106 with a conventional publishing software to create product package 108. Conventional publishing software includes Microsoft Word and Corel WordPerfect. In other implementations, seller computer 204-i uses program 106 independent of a publishing software to create product package 108. Implementations of program 106 are later described in reference to a method 400.

In action 306, seller computer 204-i sends product package 108 to aggregator computer 202 via network 224 in the normal manners. One skilled in the art understands that any of sellers 104-1 to 104-m can use any of seller computers 204-1 . . . 204-i . . . 204-m (FIG. 2) in method 300.

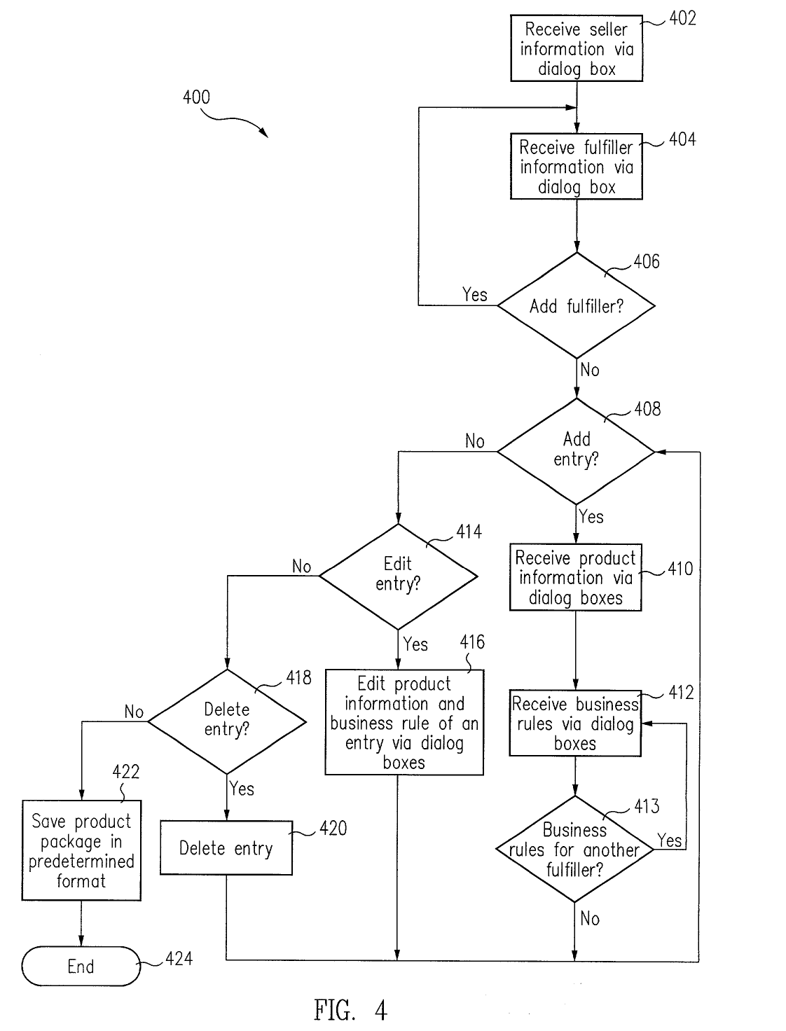

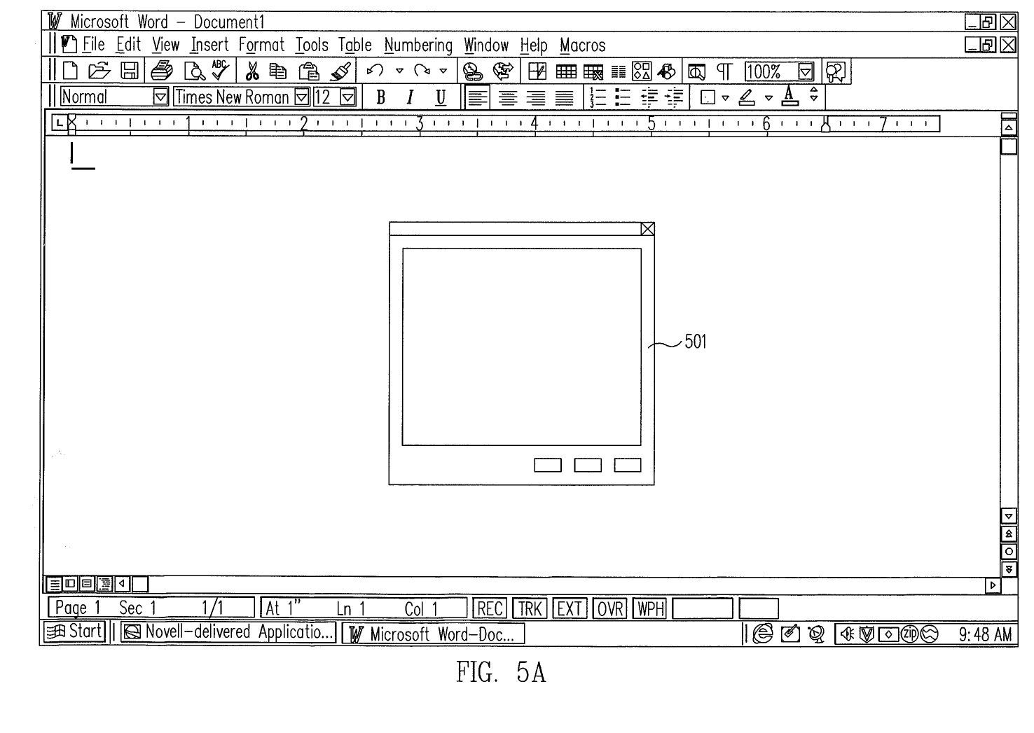

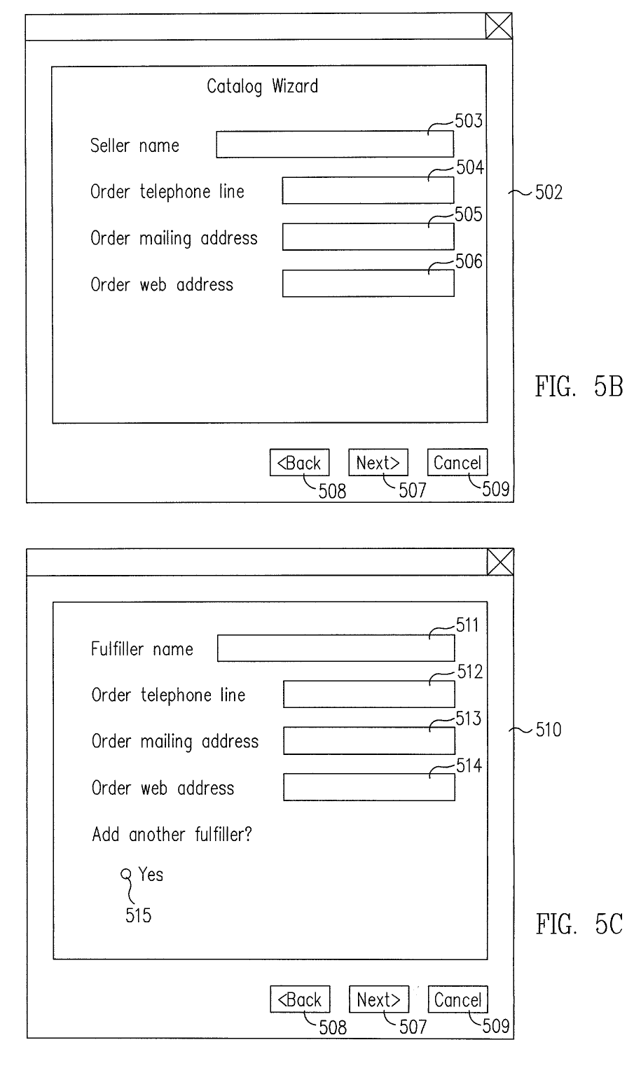

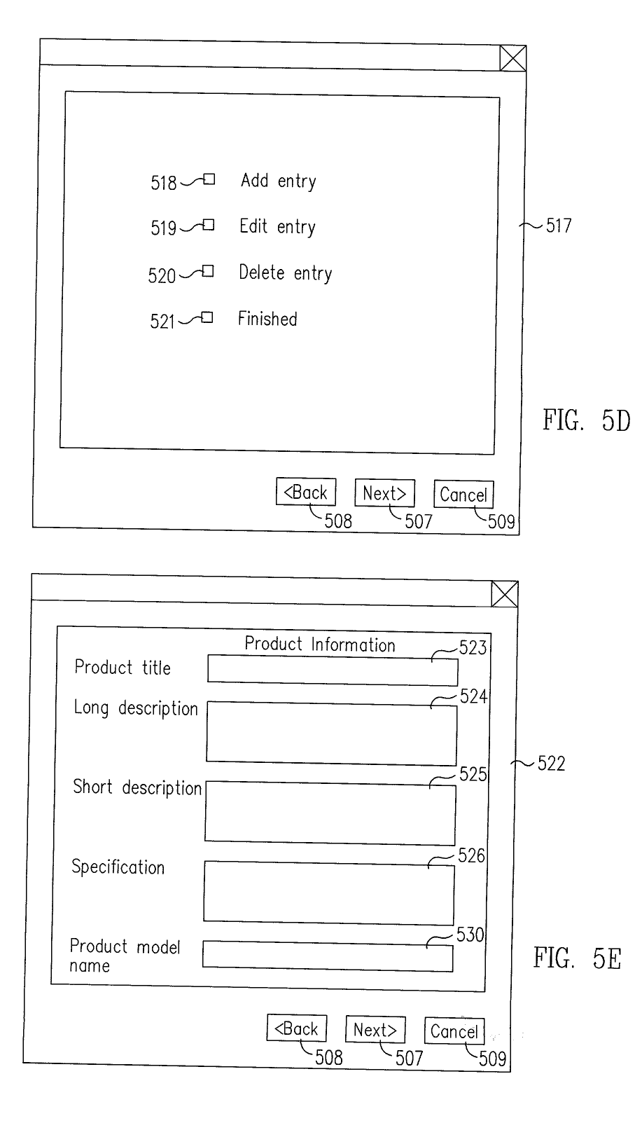

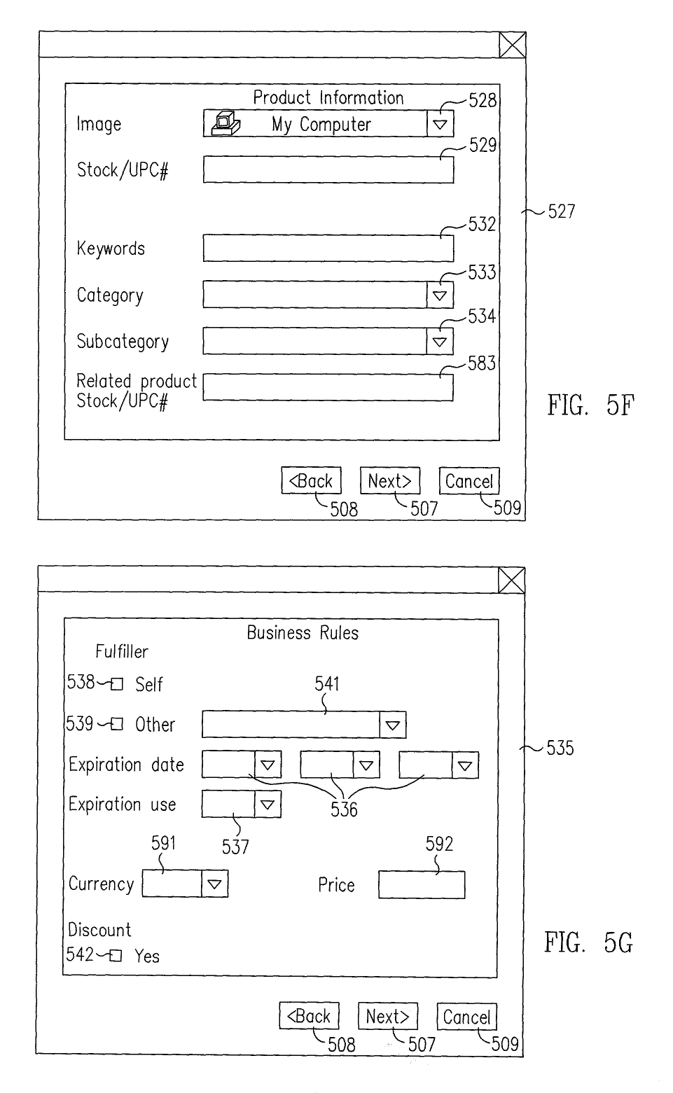

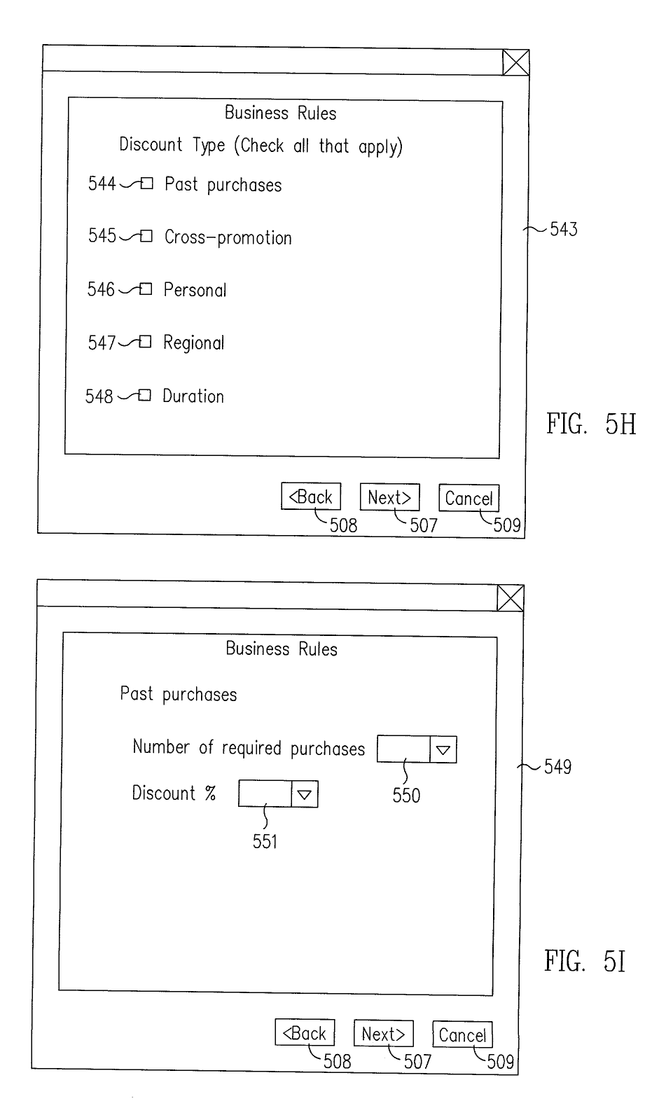

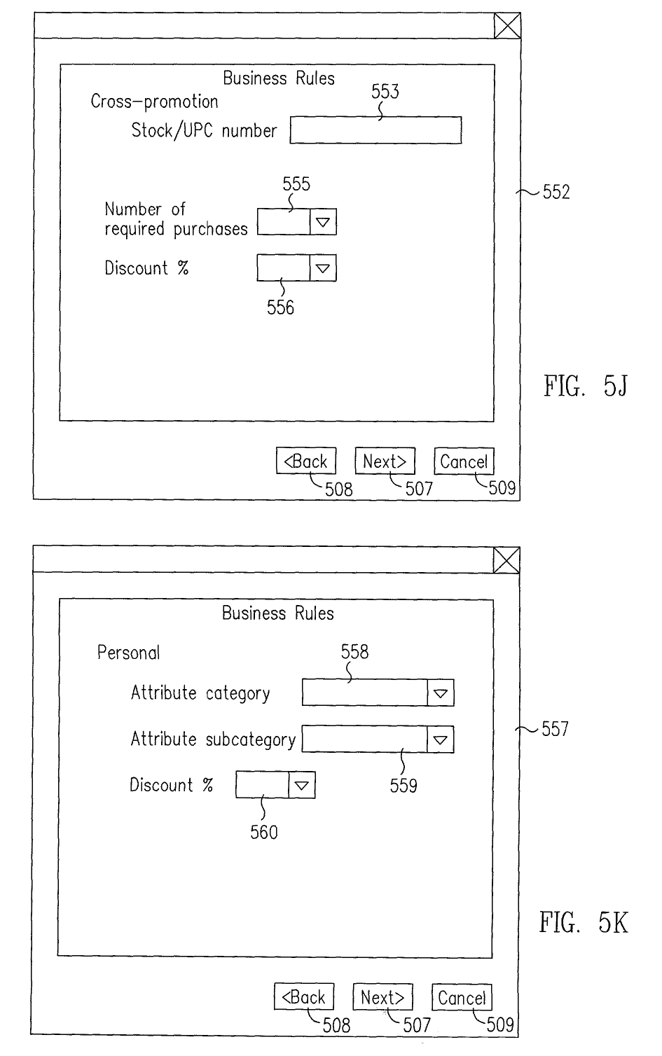

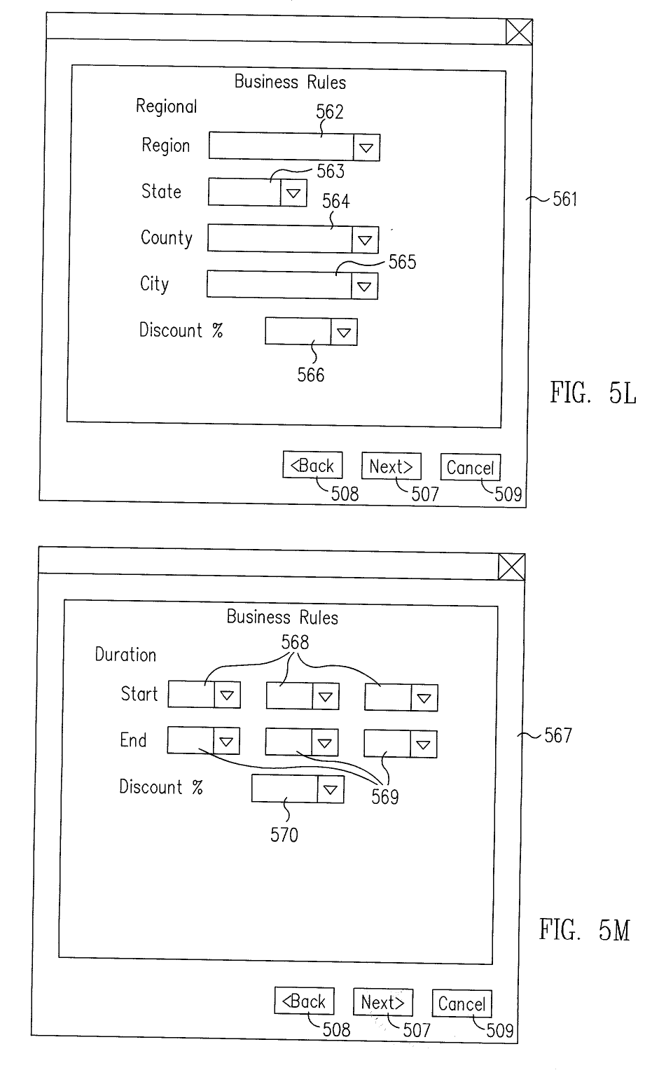

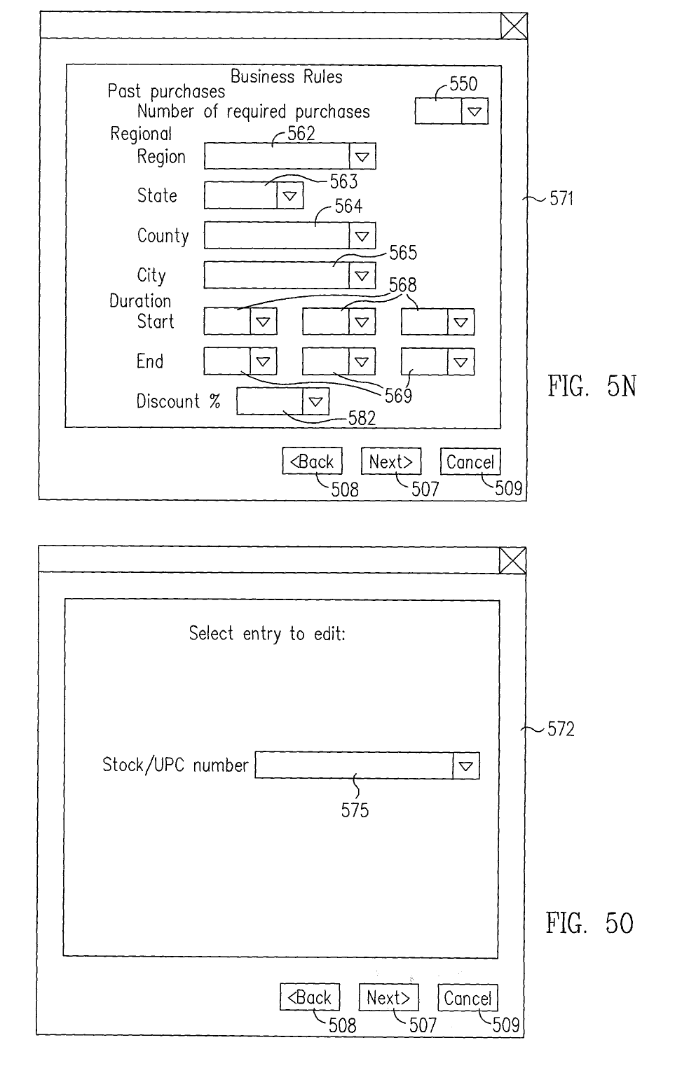

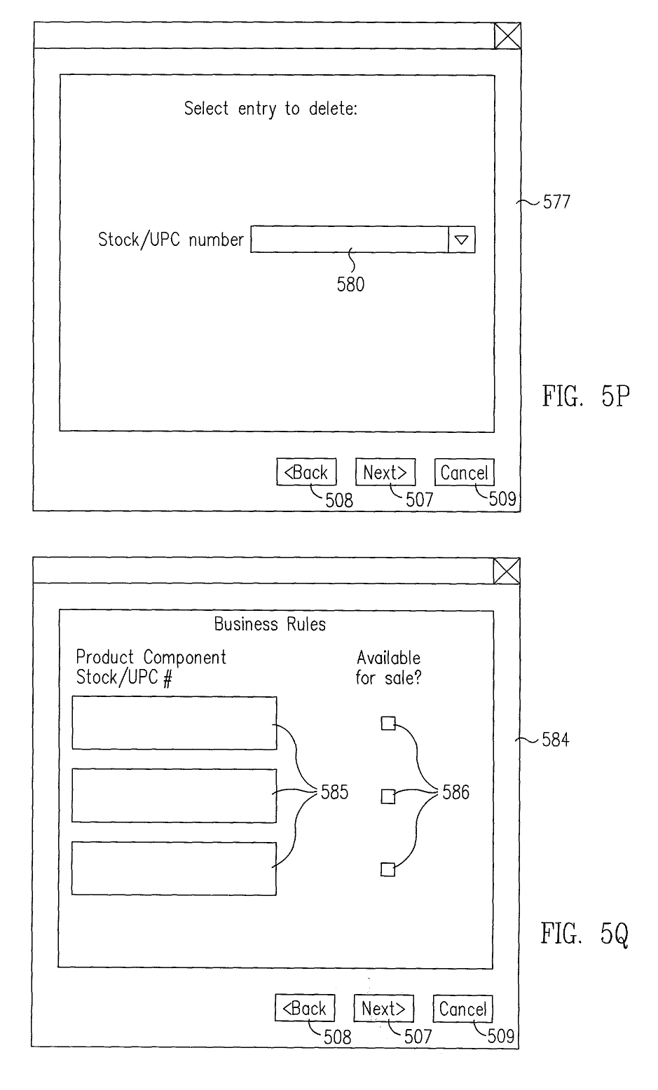

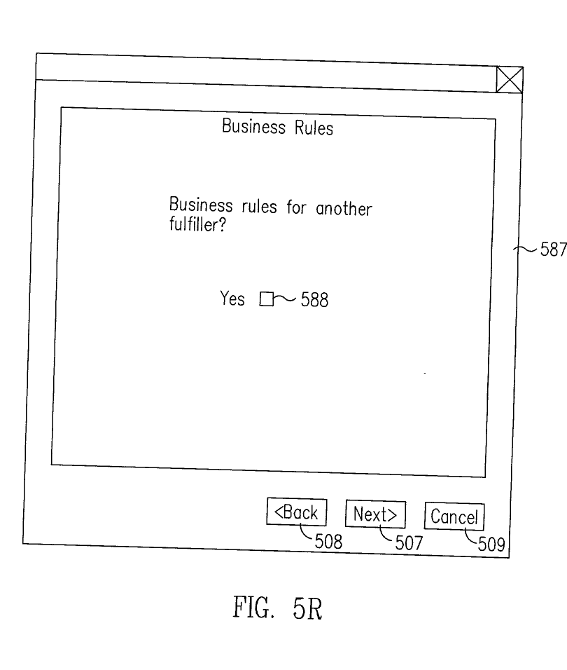

Method 400 (FIG. 4) illustrates the actions of seller computer 204-i executing program 106 with a conventional publishing software in some implementations. In some variations, program 106 is a macro for Microsoft Word written in a computer language such as Visual Basic. In these variations, seller computer 204-i displays dialog boxes (e.g., dialog box 501 in FIG. 5A) that include check boxes, text boxes, and drop-down lists used by seller 104-i to provide product information and business rules. Although not shown in FIG. 5A, such boxes are normally labeled, e.g. see FIGS. 5B and 5C. Seller computer 204-i uses responses of a seller in the checked boxes, entered texts, and selected items to generate product package 108.

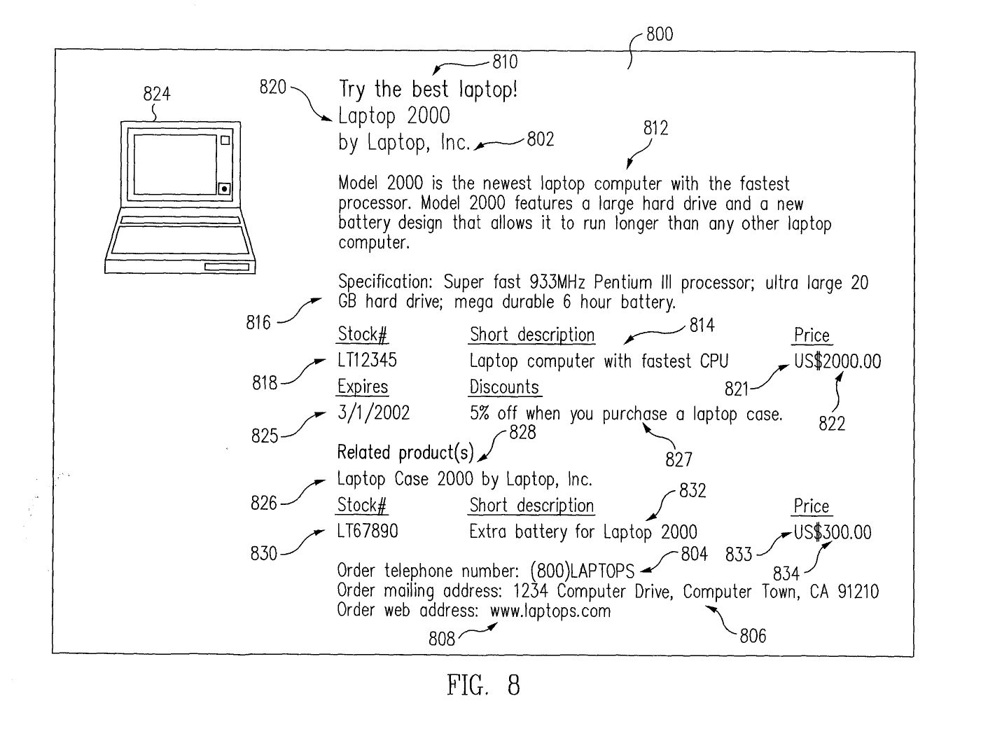

In action 402, seller computer 204-i receives seller information via a seller information dialog box 502 (FIG. 5B). In some embodiments, dialog box 502 includes a text box 503 for a seller name 802 (shown later in FIG. 8), a text box 504 for an order telephone line 804 (FIG. 8), a text box 505 for an order mailing address 806 (FIG. 8), and a text box 506 for an order web address 808 (FIG. 8). Dialog box 502 may have additional text boxes for other information necessary for a legally binding contract to be formed between a buyer 116-j and a seller 104-i for the sale of a product. Once seller 104-i has entered the requested information, seller 104-i clicks a next button 507 to proceed to the next dialog box. At any time seller 104-i can return to a previous dialog box by clicking a back button 508, or cancel program 106 by clicking a cancel button 509.

In action 404, seller computer 204-i receives fulfiller information via a fulfiller information dialog box 510 (FIG. 5C). A fulfiller is an entity retained by seller 104-i to perform services including warehousing, selling, and/or delivering products. Fulfiller includes logistic service providers, retailers, and resellers. Depending on the embodiment, a seller 104-i may itself perform the role of a fulfiller.

In some embodiments, dialog box 510 includes a text box 511 for a fulfiller name, a text box 512 for an order telephone line, a text box 513 for an order mailing address, and a text box 514 for an order web address. Seller 104-i can add an additional fulfiller by clicking a button 515. Dialog box 510 may include additional text boxes for other information necessary for buyer 116-j to contact the fulfiller for product order and/or delivery.

In action 406, seller computer 204-i determines if seller 104-i wishes to add another fulfiller (e.g., if seller 104-i checked box 515). If so, action 406 is followed by action 404 where seller computer 204-i again displays dialog box 510. Otherwise, action 406 is followed by action 408.

In action 408, seller computer 204-i determines if seller 104-i wishes to add a product entry in product package 108. In one implementation, seller computer 204-i displays a dialog box 517 (FIG. 5D) to seller 104-i. Dialog box 517 includes a check box 518 to add a product entry, a check box 519 to edit a product entry, a check box 520 to delete a product entry, and a check box 521 to end program 106. If seller 104-i selects check box 518, action 408 is followed by action 410. Otherwise, action 408 is followed by action 414.

In action 410, seller computer 204-i receives product information via dialog boxes 522 and 527 (FIGS. 5E and 5F, respectively). Dialog box 522 includes a text box 523 for a product title 810 (FIG. 8), a text box 524 for a long description 812 (FIG. 8) of the product, a text box 525 for a short description 814 (FIG. 8) of the product, a text box 526 for a specification 816 (FIG. 8) of the product, and a text box 530 for a product model name 820 (FIG. 8).

Dialog box 527 includes a text box 529 for a stock number or a universal product code (UPC) 818 (FIG. 8), a text box 532 for search keywords, and a text box 583 for one or more stock or UPC number 830 (FIG. 8) of related products. Dialog box 527 also includes a drop-down list 528 for selecting an image file 824 (FIG. 8) of the product, a drop-down list 533 for selecting a product category, and a drop-down list 534 for selecting a product subcategory. Dialog box 527 may include additional check boxes, text boxes, and drop-down lists for other information necessary to generate a product advertisement in a catalog.

The stock or UPC number provided in text box 583 allows products to be associated with other products. When a catalog is later generated, related products can be displayed in the listing of associated products as additional advertisement to spur sales of the related products.

In action 412, seller computer 204-i receives business rules for the product via a series of dialog boxes. In a dialog box 535 (FIG. 5G), seller 104-i selects a check box 538 if seller 104-i is to fulfill the orders from buyers 116-1 to 116-n. Seller 104-i selects a check box 539 and a fulfiller from a drop-down list 541 if seller 104-i uses a fulfiller to fulfill the orders from buyers 116-1 to 116-n. The fulfillers listed in drop-down list 541 are the fulfillers seller 104-i provided in action 404. Seller 104-i selects the expiration date for the product information from drop-down lists 536 and the number of times the product can be purchased from drop-down list 537 for this particular fulfiller. Seller 104-i provide a price 822 (FIG. 8) of the product from this particular fulfiller via a drop-down list 591 for a currency type 821 (FIG. 8) and a text box 592 for the price. Seller 104-i also selects a check box 542 if seller 104-i elects to provide one or more discounts for the product for this particular fulfiller.

If seller 104-i elects to provide a discount for the product, seller computer 204-i displays a discount type dialog box 543 (FIG. 5H). In dialog box 543, seller 104-i selects (1) a check box 544 for a discount based on the number of past purchases of the product, (2) a check box 545 for a discount based on the purchase of another products (cross-promotion), (3) a check box 546 for a discount based on the profile or attribute of the buyer, (4) a check box 547 for a discount based on the region or location of the buyer, and (5) a check box 548 for a discount that is valid for a specified duration. As one skilled in the art recognizes, additional types of discounts may be added.

Seller 104-i provides the details for the discount based on the number of past purchases of the product in a dialog box 549 (FIG. 5I). Dialog box 549 includes a drop-down list 550 for selecting the number of past purchases of the product to qualify for this discount, and a drop-down list 551 for selecting the discount percentage off the price listed in the product information provided in action 410. For example, seller 104-i offers 5% or 10% discount for a purchase of 5 items or 10 items, respectively.

Seller 104-i provides the details for discount based on the cross-promotion of another product in a dialog box 552 (FIG. 5J). The cross-promoted product can be from the same or different seller. Dialog box 552 includes a text box 533 for a stock or UPC number of the cross-promoted product. Seller 104-i can use either a stock or a UPC number to identify the cross-promoted product. Dialog box 552 also include a drop-down list 555 for selecting the number of past purchases of the cross-promoted product to qualify for the discount, and a drop-down list 556 for selecting the discount percentage. For example, seller 104-i offers 5% discount on a product when a buyer purchases 5 of the cross-promoted product.

Seller 104-i provides the details for the discount based on the profile or attribute of the buyer in a dialog box 557 (FIG. 5K). Dialog box 557 includes a drop-down list 558 for selecting an attribute category that qualifies for the discount, a drop-down list 559 for selecting an attribute subcategory that qualified for the discount, and a drop-down list 560 for selecting a discount percentage. For example, seller 104-i offers 5% discount on a book to a buyer that is an avid reader.

Seller 104-i provides the details for the discount based on the region or location of the buyer in a dialog box 561 (FIG. 5L). Dialog box 561 includes a drop-down list 562 for selecting a region qualified for the discount, a drop-down list 563 for selecting a state qualified for the discount, a drop-down list 564 for selecting a county qualified for the discount, a drop-down list 565 for selecting a city qualified for the discount, and a drop-down list 566 for selecting a discount percentage. For example, seller 104-i offers 5% for buyers within California.

Seller 104-i provides the details for the discount that is valid for a specified duration in a dialog box 567 (FIG. 5M). Dialog box 567 includes drop-down lists 568 for selecting a start date of the discount, drop-down lists 569 for selecting an end date of the discount, and a drop-down list 570 for selecting a discount percentage. For example, seller 104-i offers 5% discount for 10 days.

In some variations, the concurrent selection of multiple types of discounts in dialog box 543 (FIG. 5H) allows seller 104-i to create a discount with conditions from the selected discounts in a dialog box 571 (FIG. 5N). In dialog box 571, seller 104-i sets the conditions for each of the selected discounts. For example, dialog box 571 contains the conditions for a discount based on past purchases of the product (text box 550), the region or location of the buyer (text boxes 562 to 565), and a specified duration (text boxes 568 and 569) if seller 104-i has selected these discounts in dialog box 543. A buyer must meet all the conditions set in dialog box 571 to qualify for a discount percentage selected in a drop-down list 582. For example, seller 104-i offers 5% discount valid for one year to buyers that have purchased 5 items and live in California.

Seller 104-i provides information on the components that make up the product in a dialog box 584 (FIG. 5Q). For example, seller 104-i provides a stock or UPC number of a component of the product in one of text boxes 585. Seller 104-i also selects one of check boxes 586 if the corresponding component is individually available for sale. Thus, seller 104-i can decide whether buyer 116-j can purchase a part of the product instead of the entire product. Product information and business rules regarding the components of the product can be provided in other product entries in the manner described above. Furthermore, components of the product can be further divided into sub-components also provided in other product entries in the manner described above.

In action 413, seller computer 204-i determines if seller 104-i wishes to provide business rules for another fulfiller. In one implementation, seller computer 204-i displays a dialog box 587 (FIG. 5R) to seller 104-i. If seller 104-i selects check box 588, action 413 is followed by action 412 where seller computer 204-i again displays the previously described business rule dialog boxes. Otherwise, action 413 is followed by action 408 where seller computer 204-i again determines if seller 104-i wishes to add a product entry in product package 108.

In action 414, seller computer 204-i determines if seller 104-i wishes to edit a product entry in product package 108. As previously described, seller computer 204-i displays a dialog box 517 (FIG. 5D) to seller 104-i that includes a check box 519 to edit a product entry. If seller 104-i selects check box 519, action 414 is followed by action 416. Otherwise, action 414 is followed by action 418.

In action 416, seller computer 204-i displays a series of dialog boxes that allow seller 104-i to edit a prior product entry. Seller 104-i first identifies the entry to be edited in a dialog box 572 (FIG. 5O). Dialog box 572 includes a drop-down list 575 for selecting a stock or UPC number of the product. After seller 104-i identifies the product entry to be edited, seller computer 204-i provides the product information and business rules dialog boxes previous described (FIGS. 5E to 5N, 5Q and 5R) so that seller 104-i can edit the entries and selections in these dialog boxes. Action 416 is followed by action 408 where seller computer 204-i again determines if seller 104-i wishes to add a product entry in the product package.

In action 418, seller computer 204-i determines if seller 104-i wishes to delete a product entry in the product package. As previously described, seller computer 204-i displays a dialog box 517 (FIG. 5D) to seller 104-i that includes a check box 520 to delete a product entry. If seller 104-i selects button 520, action 418 is followed by action 420. Otherwise, action 418 is followed by action 422.

In action 420, seller computer 204-i displays a dialog box 577 (FIG. 5P) where seller 104-i selects an entry to be deleted. Dialog box 577 includes a drop-down list 580 for selecting a stock or UPC number of the product to be deleted. After seller 104-i identifies the product entry to be deleted, seller computer 204-i deletes that entry from product package 108. Action 420 is followed by action 408 where seller computer 204-i again determines if seller 104-i wishes to add a product entry in the product package.

In action 422, seller computer 204-i saves product package 108 in a document of a predetermined format where information provided in actions 410 and 412 are identified by descriptors. Product package 108 contains all the product entries provided above. Seller computer 204-i can also save as a business rule in each product entry an identification of seller 104-i and a date on which seller 104-i created the product entry. This information can be used by seller 104-i to track the distribution of product package 108 when it is transmitted from one aggregator to another.

In one implementation, seller computer 204-i saves the product package as an extensible markup language (XML) document where XML tags are used to identify all the product information and business rules provided by seller 104-i. Seller computer 204-i wraps XML tags around individual product information and business rules so that they can be recognized and manipulated (e.g., converted to other file formats and/or presented in a particular way) by aggregator computer 202. Depending on the implementation, seller computer 204-i can use a set of XML tags created by aggregator 102 or another party. The XML tags can be defined by a document such as a Document Type Definition (DTD) or an XML schema. Action 422 is followed by action 424, which ends method 400.

In view of the above disclosure, one skilled in the art understands that the functions of program 106 described above can also be implemented in a stand-alone computer program that is independent of a publishing software such as Microsoft Word or Corel WordPerfect.

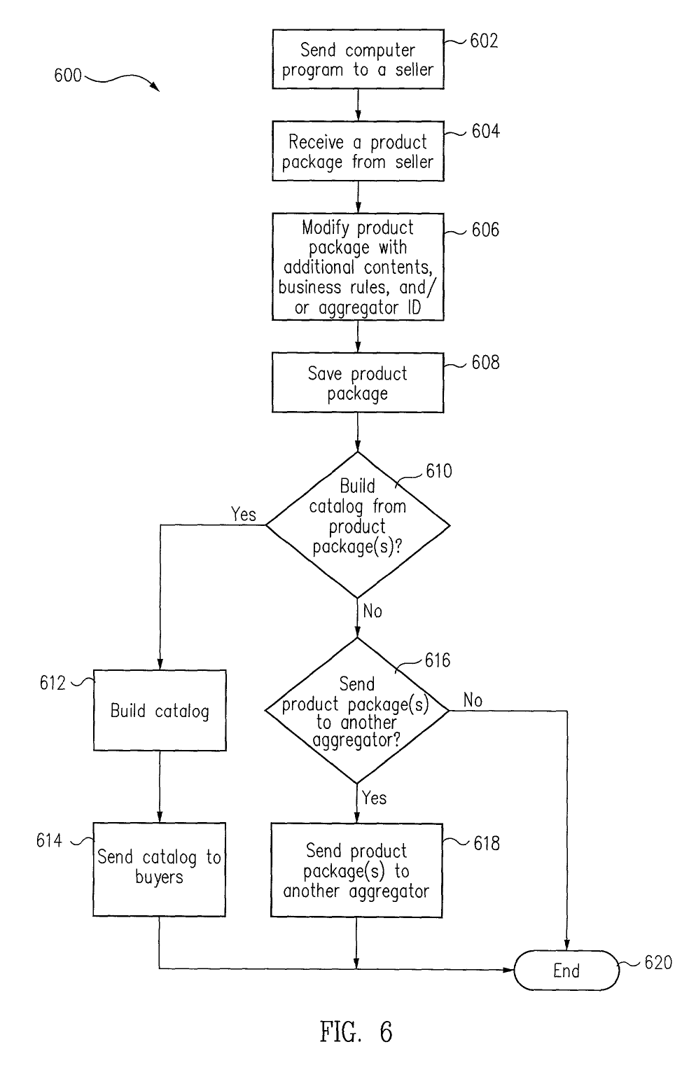

Method 600 (FIG. 6) illustrates the actions of aggregator computer 202 used by aggregator 102 in one embodiment of the invention. In action 602, aggregator computer 202 sends program 106 to seller computer 204-i via network 224 in the normal manners. Action 602 corresponds to action 302 of FIG. 3. In action 604, aggregator computer 202 receives product package 108 from seller computer 204-i via network 224 in the normal manners. Action 504 corresponds to action 306 of FIG. 3.

In action 606, aggregator computer 202 modifies product package 108. In some implementations, aggregator computer 202 adds additional product information and/or business rules for the products listed in product package 108. In one example where product package 108 includes listings of homes for sale, aggregator computer 202 adds additional product information including local zoning laws and school district information for the listed homes.

In other implementations, aggregator computer 202 includes links to related products (e.g., adding additional related products such as those entered in text box 583 of FIG. 5F) in the product entries of product package 108. In one example where product package 108 includes a cook book, aggregator computer 202 adds links to the product entry for a cookware to the cook book product entry. As described later, aggregator computer 202 can use these links to generate a catalog where each product listing includes advertisement for related products.

In yet other implementations, aggregator computer 202 includes an identification of aggregator 102 in the product entries of product package 108. For example, aggregator computer 202 includes in business rule 112 the identification of aggregator 102. The identifications of the aggregators in the product entries allow the seller to track the aggregators that are in the chain of distribution of the product packages. The tracking of the aggregators in the chain of distribution allows the seller to compensate these aggregators for promoting a product when the product is sold. The compensation of aggregators encourages distribution of the product packages between aggregators, thereby increasing the number of catalogs that include the seller's products. The compensation of the aggregators can be a single tiered scheme where all the aggregators are paid the same amount when a product is sold, or a multi-tiered scheme where the compensation depends on the position of an aggregator in the distribution chain.

In action 608, aggregator computer 202 saves product package 108 in a database 203. In some implementations, aggregator computer saves the XML tags and the data identified by the XML tags as described in U.S. patent application Ser. No. 09/536,192, entitled “REPOSITORY FOR PUBLISHING CONTENT IN DIFFERENT FORMS”, inventors Tam et al., filed Mar. 17, 2000, which is incorporated by reference herein in its entirety. In other implementations, aggregator computer 202 saves each product entry of product package 108 as an individual entry in database 203.

Aggregator computer 202 can create codes (“transaction identifiers”) that identify unique sales transactions of the products in product package 108 between buyer 116-j and seller 104-i if aggregator computer 202 has information about the buyer such as the buyer's name, address, and billing information. These codes can be saved in database 203 and be provided to buyer 116-j as a part of catalog 114. Buyer 116-j can purchase a product simply by sending the transaction identifier to aggregator 102 or another entity (e.g., a financial clearinghouse) that can process the order through its access to database 203. Additional details regarding the transaction identifiers are described in U.S. patent application Ser. No. ______, entitled “E-COMMERCE USING AN IDENTIFIER”, inventors Tam et al., filed ______, attorney docket number M-9127 US, which is incorporated by reference in its entirety.

In action 610, aggregator computer 202 detects if aggregator 102 wishes to generate catalog 114 from one or more product packages. If so, action 610 is followed by action 612. Otherwise, action 610 is followed by action 616.

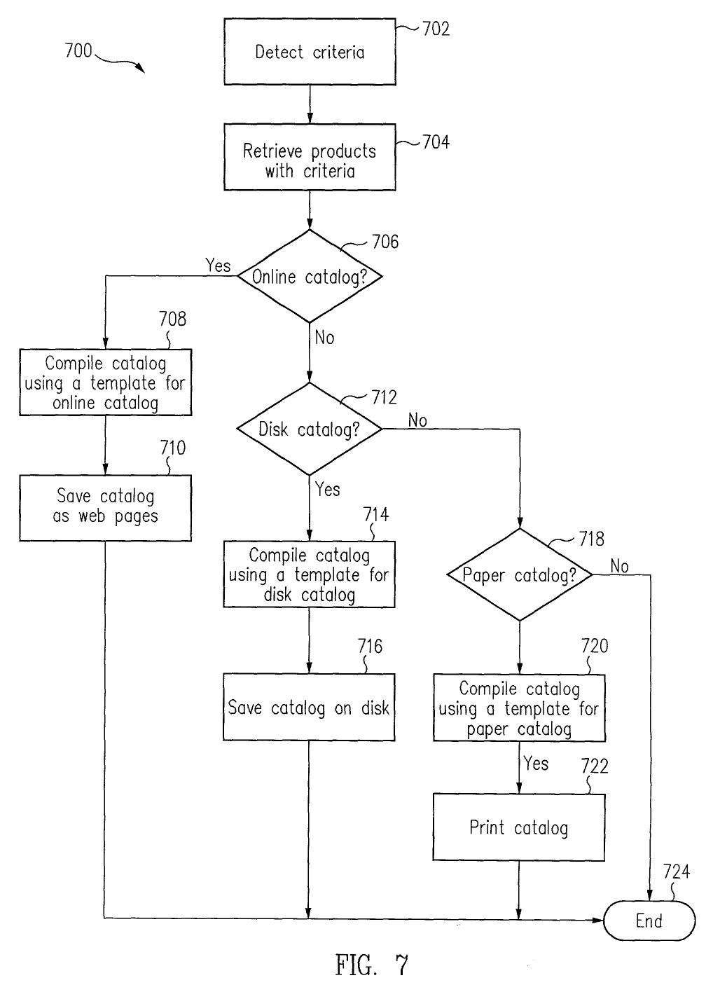

In action 612, aggregator computer 202 builds catalog 114 from one or more product packages (e.g., product package 108). Action 612 is later described in reference to FIG. 7. In action 614, aggregator computer 202 sends catalog 114 to buyers. In some implementations, catalog 114 is an online catalog that aggregator computer 202 sends as web pages in response to a request by a buyer computer 216-j used by buyer 116-j via network 224. One skilled in the art understands that any of buyers 116-1 to 116-n can use any of buyer computers 216-1 . . . 216-j . . . 216-n (FIG. 2) to request and receive catalog 114.

In other implementations, aggregator computer 202 sends catalog 114 as an electronic catalog on a computer disk to buyer 116-j by mail. Computer disk includes magnetic disks, optical disks, and other media that carry computer data. Aggregator computer 202 can also include products for sale (e.g., electronic content including music, books, and movies) on the compute disk. These products can be made available to buyer 116-j after he or she pays seller 104-i. Seller 104-i can provide a key to unlock (e.g., decrypt) the electronic content stored on catalog 114.

In yet other implementations, aggregator computer 202 sends catalog 114 as a printed paper catalogs to buyer 116-j by mail. Action 614 is followed by action 620, which ends method 600.

In action 616, aggregator computer 202 detects if aggregator 102 wishes to send one or more product packages to another aggregator (e.g., aggregator 118). If so, action 616 is followed by action 618. Otherwise, action 616 is followed by action 620, which ends method 600.

In action 618, aggregator computer 202 sends one or more product packages to aggregator computer 218 used by aggregator 118 via network 224 in the normal manners. Aggregator computer 218 can similarly process the product packages from sellers and aggregators as described in actions 606, 608, 610, 612, 614, 616, 618, and 620. Aggregator computer 218 includes a database 219 (FIG. 2) where aggregator computer 218 saves product packages from sellers and other aggregators.

Product information and business rules vary between different industries and applications. Tables 1 and 2 below provide exemplary XML tags for product information and business rules for selling publications (e.g., books).

TABLE 1
Product Information

| Tag | Definition |
|---|---|
| <publication id = “s-49602-315-x” type | Publication id and type of |
| = “ISBN”/> | publication id (e.g., |
| | ISBN number) |
| <publisher “iUniverse.com”/> | Publisher of the publication |
| <pub_place = “Campbell, CA”/> | Publication place |
| <title = “A Customized Book”/> | Title of the publication |

TABLE 2
Business Rules

| Tag | Definition |
|---|---|
| <price_algorithm = | Specifies the pricing algorithm for the |
| “even_chapter_pricing”/> | publication. For example, the seller can |
| | sell a book consisting of chapters as |
| | individual chapters at the same fixed |
| | price. Alternatively, the seller can sell |
| | the individual chapters at different fixed |
| | prices that depend on the value of the |
| | chapter, the number of pages, or the |
| | sale of the chapter. |
| <DRM_flags = “0101010”/> | Specifies the digital rights of the |
| | publication. For example, the first digit |
| | determines whether the buyer can print |
| | the publication, the second digital |
| | determine whether the buyer can save |
| | the publication, the third digit |
| | determines whether the buyer can edit |
| | the publication, the fourth digit |
| | determines whether the buyer can |
| | annotate the publication, the fifth digit |
| | determines if the buyer can copy the |
| | publication, and the sixth digit |
| | determines if a buyer can view the |
| | publication. |
| <customization = “yes”/> | Specifies whether the publication can be |
| | combined with other publications to |
| | form a customized publication. |
| <personalization = “yes”/> | Specifies whether the publication can be |
| | personalized with content from the |
| | buyer such as a dedication or a forward. |
| <geographic_limitation = | Specifies the geographic area where the |
| “US”/> | publication can be distributed. |
| <format ebook = “yes” | Specifies the format which the |
| print_on_demand = “no” | publication is available in. |
| web = “yes”/> | |
| <source original = | Specifies the source of the original |
| “iUniverse.com”/> | product entry. |
| <source copy = | Specifies an aggregator that is in the |
| “myfirstdistributor” | distribution chain of the product entry |
| date = “mmddyy”/> | and the date which the aggregator |
| | received the product entry. |
| <component part = “Chapter 1” | Specifies a component of the |
| type = “publication” id = | publication. For example, the |
| “s-49602-8316-x”/> | component is chapter 1 of the |
| | publication. The component is |
| | identified by its type and its ID. |

As Table 2 shows, a product can be made of components individually available for sale. The product entry for the product is linked to product entries of the components by their publication IDs. The product entries for the components have the same or similar types of product information and business rules as the product entry for the product. Similarly, the components themselves can be made of sub-components individually available for sale and recorded in other product entries in the product package.

Method 700 (FIG. 7) is one embodiment of action 612. In action 702, aggregator computer 202 detects one or more product criteria chosen by aggregator 102 to build catalog 114. Product criteria are any characteristics of the product, the seller, the fulfiller that aggregator 102 elects to use to decide what product to include or exclude in catalog 114. Thus, product criteria are used to customize catalog 114 for a single buyer, a group of buyers, or a region of catalog distribution. Product criteria include product information expiration date, product category, product subcategory, discount type, discount conditions, seller of the product, fulfiller of the product, price range, distribution and reproduction rights of the products (e.g., IP material), bundling of products (e.g., sets, collections, and anthologies), and any of the previously described business rules.

In action 704, aggregator computer 202 retrieves the product entries with the chosen criteria from database 203 and saves these product entries in an XML document (e.g., assembles the product entries into an XML document). Alternatively, aggregator computer 202 retrieves the product entries without the chosen criteria from database 203 and saves these product entries in an XML document. In action 706, aggregator computer 202 detects if aggregator 102 wishes to create an online catalog. If so, action 706 is followed by action 708. Otherwise, action 706 is followed by action 712.

In action 708, aggregator computer 202 generates an online catalog 114 from the XML document using a template (e.g., a style sheet). In some embodiments, the template is specifically designed to generate web pages for display on browser programs such as Microsoft Explorer or Netscape Navigator. In some implementations, the template is an extensible style language (XSL) style sheet that aggregator computer 202 uses to format the presentation of the XML document and to transform the XML document into a document in another computer language such as hypertext markup language (HTML). In some embodiments, aggregator computer 202 includes static offers with words of commitment to sell and specific terms generated from business rules 112 in the web pages that form catalog 114. In other embodiments, aggregator computer 202 dynamically generates the specific terms of the offer from business rules 112 stored in database 203 when buyer 116-j browses online catalog 114.

In action 710, aggregator computer 202 saves catalog 114. Action 710 is followed by action 724, which ends method 700.

In action 712, aggregator computer 202 detects if aggregator 102 wishes to create an electronic catalog distributed on a computer disk. If so, action 712 is followed by action 714. Otherwise, action 712 is followed by action 718.

In action 714, aggregator computer 202 generates an electronic catalog 114 from the XML document using a template. In some embodiments, the template is specifically designed to generate web pages for display on browser programs such as Microsoft Explorer or Netscape Navigator from computer disks. In some implementations, the template is an XSL style sheet that aggregator computer 202 uses to format the presentation of the XML document and to transform the XML document into an HTML document. In some embodiments, aggregator computer 202 includes static offers with words of commitment to sell and specific terms generated from business rules 112 in the product listings of electronic catalog 114. In other embodiments, aggregator computer 202 saves business rules 112 in electronic catalog 114 so the specific terms of the offer can be dynamically generated when buyer 116-j browses catalog 114.

In action 716, aggregator computer 202 saves catalog 114 on computer disks to be distributed to buyers 116-1 to 116-n. Alternatively, aggregator 102 uses a disk vendor to mass produce catalog 114 on computer disks. Action 716 is followed by action 724, which ends method 700.

In action 718, aggregator computer 202 detects if aggregator 102 wishes to create a paper catalog. If so, action 718 is followed by action 720. Otherwise, action 718 is followed by action 724, which ends method 700.

In action 720, aggregator computer 202 generates a paper catalog 114 from the XML document using a template. In some embodiments, the template is specifically designed for generating a paper catalog. In some implementations, the template is an XSL style sheet used by aggregator computer 202 to format the presentation of the XML document and to transform the formatted the XML document to a portable document format (PDF) file using commercial PDF software such as Acrobat Distiller from Adobe of San Jose, Calif. In some embodiments, aggregator computer 202 includes static offers with words of commitment to sell and specific terms generated from business rules 112 in the product listings of paper catalog 114. In action 722, aggregator computer 202 prints catalog 114 from the PDF file. Alternatively, aggregator 102 sends the PDF file to a commercial printer to print catalog 114. Action 720 is followed by action 724, which ends method 700.

FIG. 8 illustrates an exemplary layout of a product listing 800 of catalog 114 generated by aggregator computer 202 in actions 708, 714, and 720. A first portion of listing 800 includes information on the product for sale. For example, the first portion includes product title 810, product model name 820, seller name 802, long description 812, specification 816, stock number 818, short description 814, currency type 821, price 822, product image 824, expiration of offer 825, and cross-promotion 827.

A second portion, located below the first portion, includes information on a related product for sale. For example, the second portion includes a product model name 826 of the related product, a seller name 828 of the related product, stock number 830 of the related product, a short description 832 of the related product, a currency type 833, and a price 834 of the related product. As previously described, seller 104-i can enter stock or UPC numbers of related products for each of the product entry in text box 583. Thus, aggregator compute 202 can use the stock or UPC numbers to retrieve one or more product information of the related products from database 203 and place the product information as part of the listing of its related product. A component of the product can be similarly displayed as the related product.

A third portion, located below the second portion, includes the order information of the seller. For example, the third portion includes order telephone line 804, order mailing address 806, and order web address 808. If the seller uses a fulfiller to deliver or sell products to the buyers, the third portion can include the order information of a fulfiller. If the catalog is generated for a specific buyer, transaction identifiers can also included in the third portion. Additional details regarding the transaction identifiers are described in U.S. patent application Ser. No. ______, entitled “E-COMMERCE USING AN IDENTIFIER”, inventors Tam et al., filed ______, attorney docket number M-9127 US, which is incorporated by reference in its entirety. Note that the layout shown in listing 800 is only exemplary. As one skilled in the art understands, the layout can be changed by using different templates (e.g., different XSL style sheets).

In one embodiment, product listing 800 is a legally binding offer to sell that includes words of commitment to sell and specific terms that are defined by the business rules 112 provided by seller 104-i. Business rules 112 can be used to dynamically create the offer when product listing 800 is part of an electronic catalog. Various dialog boxes can be generated using business rules 112 to define the terms of the offer to buyer 116-j. For example, dialog boxes can be used to allow the buyer 116-j to select the quantity, the delivery method, and other specific terms of the offer.

Although the invention has been described with reference to particular embodiments, the description is only of examples and should not be taken as a limitation. For example, a catalog as described herein need not be limited to products but maybe used for services. Various other adaptations and combinations of features of the embodiments disclosed are within the scope of the invention as defined by the following claims.

We claim:

1. A method for building a catalog, comprising:
receiving a plurality of documents from sellers, each document including information about at least one product or service (hereinafter “item”) offered for sale and a business rule governing sale of the item;
generating a catalog containing at least a group of said documents;
wherein a document from the plurality of documents received from the sellers is included in the catalog if at least a portion of the information or the business rule meets a predetermined criterion; and
distributing the catalog to a plurality of buyers.

2. The method of claim 1, wherein at least one of the plurality of documents from the sellers is an XML document and the information and the business rule of the item are identified by XML tags.

3. The method of claim 1, wherein said generating the catalog comprises creating an online catalog received by the buyers via a network.

4. The method of claim 3, wherein said creating the online catalog comprises applying a template to at least the document.

5. The method of claim 1, wherein said generating the catalog comprises:
creating an electronic catalog from the group of documents; and
saving the electronic catalog on computer disks distributed to the plurality of buyers.

6. The method of claim 5, wherein said creating comprises applying a template to at least the document.

7. The method of claim 1, wherein said generating the catalog comprises creating a paper catalog.

8. The method of claim 7, wherein said creating comprises applying a template to at least the document.

9. The method of claim 1, further comprising sending a computer program for authoring the document to a seller.

10. The method of claim 1, further comprising sending another document from the plurality of documents to another party for inclusion in another catalog.

11. The method of claim 1, further comprising adding additional information or adding an additional rule prior to generating the catalog.

12. The method of claim 11, wherein the additional information includes an identifier of a cross-promoted item.

13. The method of claim 11, wherein the additional information includes additional description of the item.

14. The method of claim 1, wherein the business rule includes a method for determining a discount.

15. The method of claim 1, wherein the business rule includes at least one identifier of a component of the item.

16. The method of claim 15, wherein the document further includes additional information about the component and an additional business rule governing the sale of the component.

17. The method of claim 1, wherein the business rule includes an identifier of the seller.

18. The method of claim 1, wherein the business rule includes a date on which the seller created the first document.

19. The method of claim 11, wherein the additional rule includes an identifier of a party that received the document.

20. The method of claim 11, wherein the additional rule further includes a date on which a party received the document.

21. The method of claim 1, further comprising receiving payment from a seller when a buyer purchases an item from the catalog.

22. The method of claim 10, further comprising receiving payment from a seller when a buyer purchases an item described by said another document from said another catalog.

23. The method of claim 1, wherein said generating the catalog includes creating legally binding offers with words of commitment to sell and specific terms from the business rule.

24. The method of claim 1 wherein each document in said group describes an identical item offered for sale by a plurality of sellers.

25. A storage medium encoded with:
descriptive information about an item for sale; and
business rules governing the sale of the item, the business rules including identifiers of each party that has included the descriptive information and the business rule in a catalog distributed to buyers.

26. The medium of claim 25, wherein the descriptive information is identified by XML tags.

27. The medium of claim 25, wherein the business rules are identified by XML tags.

28. The medium of claim 25, wherein the business rules further include the dates on which said each party received the descriptive information and the business rules.

29. The medium of claim 25, wherein the business rules further include an identifier of the party that created the descriptive information and the business rules.

30. The medium of claim 29, wherein the business rules further include the date on which the descriptive information and the business rules are created.

31. The medium of claim 25, wherein the business rules further include discount methods for the item.

32. A system for generating a catalog, the system comprising:
a first computer including a computer program for authoring a first document comprising information descriptive of a first item and a business rule for sale of the first item;
a second computer coupled to the first computer via a network, the second computer including:
the first document received from the first computer; and
an online catalog including at least the information included in the first document; and
a third computer coupled to the second computer via the network, the third computer including a browser for accessing the online catalog in the second computer.

33. The system of claim 32, wherein the first document is an XML document and the information and the business rule are identified by XML tags.

34. The system of claim 32, further comprising a fourth computer coupled to the second computer via the network, the fourth computer including a computer program for authoring a second document comprising information descriptive of a second item and a business rule for sale of the second item.

35. The system of claim 34, wherein the second computer further includes the second document received from the fourth computer and the online catalog includes at least a portion of the second document.

36. The system of claim 32, further comprising a fourth computer coupled to the second computer via the network, the fourth computer including:
the first document received from the second computer; and
another online catalog including at least a portion of the first document.

37. A system for generating a catalog, the system comprising:
first means for authoring a first document comprising information descriptive of a first item and a business rule for sale of the first item;
second means coupled to the first means via a network, the second means including:
the first document received from the first means; and
an online catalog including at least the information included in the first document; and
third means for accessing the online catalog in the second means, the third means being coupled to the second means via the network.

38. The system of claim 37, wherein the first document is an XML document and the information and the business rule are identified by XML tags.

39. The system of claim 37, further comprising fourth means for authoring a second document comprising information descriptive of a second item and a business rule for sale of the second item, the fourth means being coupled to the second means via the network

40. The system of claim 39, wherein the second means further includes the second document received from the fourth means and the online catalog includes at least a portion of the second document.

41. The system of claim 37, further comprising fourth means coupled to the second means via the network, the fourth computer including:
the first document received from the second computer; and
another online catalog including at least a portion of the first document.

42. A method for building a catalog, comprising:
sending a computer program for authoring an electronic document to a plurality of sellers;
receiving a plurality of documents from the sellers, each document including information about at least one product or service (hereinafter “item”) offered for sale and a business rule governing sale of the item;
generating a catalog containing a group of documents, wherein a document from the plurality of documents received from the sellers is included in the catalog if at least a portion of the information or the business rule meets a predetermined criterion;
adding additional information or adding an additional rule prior to generating the catalog; and
distributing the catalog containing the information to a plurality of buyers.

43. The method of claim 42 wherein:
information in a plurality of documents described an identical item offered for sale by a number of said sellers.
